(19) United States
(12) Patent Application Publication
(10) Pub. No.: US 2010/0076812 A1
(43) Pub. Date: Mar. 25, 2010

(54) BUSINESS PERFORMANCE MEASUREMENTS

(75) Inventors: Debashis Ghosh, Charlotte, NC (US); Kurt Newman, Matthews, NC (US); David Joa, Pacifica, CA (US); Timothy J. Bendel, Charlotte, NC (US)

Correspondence Address: MOORE & VAN ALLEN, PLLC FOR BOFA, 430 DAVIS DRIVE, SUITE 500, POST OFFICE BOX 13706, RESEARCH TRIANGLE PARK, NC, 27709, US

(73) Assignee: Bank of America Corporation, Charlotte, NC (US)

(21) Appl. No.: 12/236,952

(22) Filed: Sep. 24, 2008

(51) Int. Cl. G06Q 90/00

(52) U.S. Cl. 705/10; 705/11

(57) ABSTRACT

Embodiments of the invention relate to systems, methods, and computer program products for providing a performance-measuring network for measuring the performance of a business-merchant relative to other business-merchants competing in the same or similar markets. For example, the performance-measuring network collects transaction data from a large number of different business-merchants. The performance-measuring network then assigns each of the different business-merchants to one or more peer groups. Each peer group consists of business-merchants that compete in the same or similar markets. For example, each peer group consists of business-merchants that sell similar products and/or services in the same geographic markets. After collecting transaction data and creating peer groups, the performance-measuring network measures the performance of a specific business-merchant by comparing the transaction data of the specific business-merchant to the transaction data of the other business-merchants that are assigned to the same peer group(s) as the specific business-merchant.

### FIELD

In general, embodiments of the invention relate to systems, methods, and computer program products for measuring business performance and, more particularly, to collecting transaction data from multiple businesses and comparatively measuring the performance of specific businesses relative to other businesses.

### BACKGROUND

Businesses commonly collect and analyze sales data in an attempt to measure business-value changes that resulted from management adjustments. Management adjustments include, for example, staffing changes, price refinements, changes in store layout, opening a new retail facility, closing a retail facility, etc. While collecting and analyzing historical sales data enables businesses to measure changes in sales volume, revenue, and profitability, this information alone may not be sufficient for measuring business-value changes that actually resulted from the management adjustments. This is because management adjustments are not the only cause for changes in sales volume, revenue, and profitability.

Seasonality and other market dynamics also affect sales volume, revenue, and profitability. For example, a modest decline in sales in a rapidly declining market segment may actually be good because, if the management adjustment in question had not been implemented, sales may have declined even further. Accordingly, when attempting to accurately measure business-value changes, businesses typically have to estimate the effects of seasonality and other market dynamics. These estimates are then applied to business metrics to refine the business-value measurements. This process is subjective and may yield inaccurate results.

### SUMMARY

Some embodiments of the invention relate to systems, methods, and computer program products for providing a performance-measuring network for measuring the performance of a business-merchant relative to other business-merchants competing in the same or similar markets. For example, the performance-measuring network collects transaction data from a large number of different business-merchants. The performance-measuring network then assigns each of the different business-merchants to one or more peer groups. Each peer group consists of business-merchants that compete in the same or similar markets. For example, each peer group consists of business-merchants that sell similar products and/or services in the same geographic markets. After collecting transaction data and creating peer groups, the performance-measuring network measures the performance of a specific business-merchant by comparing the transaction data of the specific business-merchant to the transaction data of the other business-merchants that are assigned to the same peer group(s) as the specific business-merchant.

### BRIEF DESCRIPTION OF THE DRAWINGS

Having thus described embodiments of the invention in general terms, reference will now be made to the accompanying drawings, wherein:

FIG. 1 illustrates an environment in which the processes described herein are implemented according to one embodiment of the invention;

FIG. 2 is a flow chart illustrating an exemplary process of generating a market-share report, in accordance to one embodiment of the present invention; and

FIG. 3 is a flow chart illustrating an exemplary process of logging into a secure website to access a performance-measuring network and generate a market-share report, according to one embodiment of the present invention.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art, the present invention may be embodied as a method (including a business process), system, computer program product, or a combination of the foregoing. Accordingly, the present invention may take the form of an entirely hardware embodiment, an entirely software embodiment (including firmware, resident software, micro-code, etc.), or an embodiment combining software and hardware aspects that may generally be referred to herein as a “system.” Furthermore, the present invention may take the form of a computer program product on a computer-readable medium having computer-usable program code embodied in the medium.

Any suitable computer-usable or computer-readable medium may be utilized. The computer-usable or computer-readable medium may be, for example but not limited to, an electronic, magnetic, optical, electromagnetic, infrared, or semiconductor system, apparatus, device, or propagation medium. More specific examples of the computer-readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device; or transmission media such as those supporting the Internet or an intranet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber cable, radio frequency (RF) signals, or other mediums.

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

The term “business-merchant” as used herein refers to any individual or any business or non-business entity that sells, distributes, trades or otherwise deals, either as a retailer or wholesaler, in goods and/or services. It should be appreciated that the term business-merchant as used herein includes individuals or business or non-business entities that produce/provide the goods and/or services being sold. It should also be appreciated that the term business-merchant as used herein includes individuals or business or non-business entities that do not produce/provide the goods and/or services being sold.

The term “transaction data” as used herein refers to any information relating to the sale of a good and/or service. Exemplary transaction data includes information about the good(s) and/or service(s) exchanged between the consumer and the business-merchant during the transaction, and information about the consumer, the business-merchant, and the transaction itself. For example, this information includes a description of the goods(s) and/or service(s), the quantity of goods(s) and/or service(s), and the price of the good(s) and/or service(s).

Also, for example, transaction data includes information about the consumer. This consumer information includes the consumer's name, bank account number, and credit- or debit-card number and the name of the card-issuing bank. Transaction data also includes, for example, information about business-merchants. This information includes the name and location of the business-merchant, the location where the exchange occurred, the name and routing number of the acquiring bank, and the account number of the business-merchant's account, which is held at the acquiring bank.

In general terms, described herein are various systems, methods, and computer program products for providing a performance-measuring network for measuring the performance of a business-merchant relative to other business-merchants competing in the same or similar markets. For example, the performance-measuring network collects transaction data from a large number of different business-merchants. The performance-measuring network then assigns each of the different business-merchants to one or more peer groups. Each peer group consists of business-merchants that compete in the same or similar markets. For example, each peer group consists of business-merchants that sell similar products and/or services in the same geographic markets. After collecting transaction data and creating peer groups, the performance-measuring network measures the performance of a specific business-merchant by comparing the transaction data of the specific business-merchant to the transaction data of the other business-merchants that are assigned to the same peer group(s) as the specific business-merchant.

A brief overview of an exemplary embodiment will now be provided. In this embodiment, the performance-measuring network collects sales volume data from each of the business-merchants that compete in a particular market, and then compares the sales volume data of a specific business-merchant to the sales volume data of the other business-merchants in the same market to determine the specific business-merchant's market share. Because, instead of estimating, the performance-measuring network collects actual sales volume data from each of the business-merchants of the relevant market, the performance-measuring network accurately determines the specific business-merchant's market share. Accordingly, the performance-measuring network eliminates the need for the specific business-merchant to estimate market dynamics and make corrections to speculative data.

An exemplary scenario will now be provided with reference to the above-mentioned exemplary embodiment, where the performance-measuring network collects sales volume. The following exemplary scenario is for illustrative purposes only and is not intended to limit the scope of the present invention. In this scenario, soon after a specific business-merchant implemented a management change, the sales volume of the overall market, including the sales volume of the specific business-merchant, declined. However, even though its sales volume declined, the management change was a good decision because the specific business-merchant's market share increased. In this example, because it had access to a market-share report, which was generated by the performance-measuring network and which indicated the specific business-merchant's market share, the specific business-merchant was able to correctly determine that the management change was not a failure and that the decline in its sales was the result of a declining market, not the result of the management change.

The performance-measuring network provides operational and cost efficiency in the management of a business by providing accurate market information. For example, in the above-mentioned scenario, the specific business-merchant knows to continue with the management change, despite decreasing sales volume.

The performance-measuring network also provides cost efficiency by reducing the costs associated with market analysis. Some businesses spend millions of dollars buying market share analysis reports from consulting firms. Often times, these reports are speculative and inaccurate. Also, some businesses spend millions of dollars conducting market research studies. These studies include convening focus groups and conducting face-to-face, telephone and web interviews. These research studies can be inaccurate and may not have a sufficient sample size to provide a comprehensive and accurate analysis of what is actually happening in the marketplace. Accordingly, in addition to reducing the resources expended on obtaining these speculative reports and market research studies, the performance-measuring network eliminates the detrimental reliance on inaccurate reports and research studies. Reliance on inaccurate reports and research studies may cause management to make improper management decisions, which may lead to revenue and profit losses.

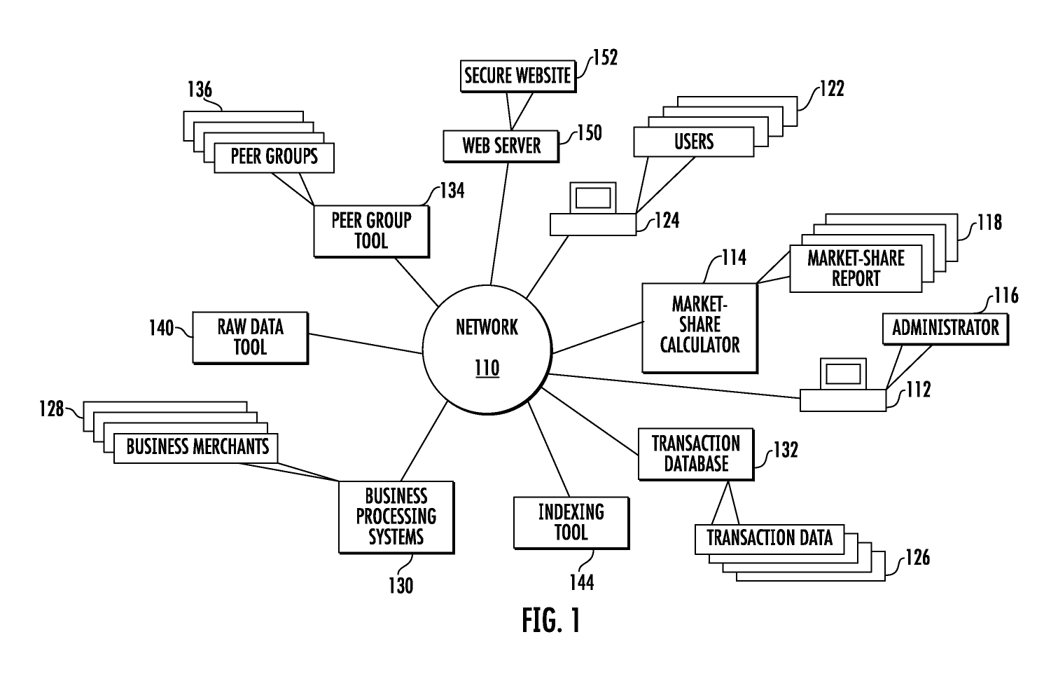

An exemplary performance-measuring network 110 is illustrated in FIG. 1. An administrative terminal 112 provides an administrator 116 with administrative access. This enables the administrator 116 to manage the performance-measuring network 110. The term “administrator” applies to any individual or business or non-business entity that manages the performance-measuring network 110. For example, an administrator 116 can be a bank or other financial institution having access to transaction data 126.

For illustrative purposes, transaction data 126 will be described herein as transaction information obtained at the point-of-sale when a consumer purchases a good or service from a business-merchant 128 using a credit or debit card. It should be appreciated, however, that transaction data 126 could be obtained from other types of transactions. For example, transaction data 126 could be obtained from contactless payments, ACH payments, Bill Pay payments, check payments, and cash payments.

Banks are suitable administrators 116 for managing the performance-measuring network 110 because, when a consumer makes a purchase, either online or in a store, the business-merchant 128 sends related transaction data 126 via a payment gateway to the merchant's acquiring bank, which is the bank that accepts payments for the goods or services on behalf of the business-merchant 128. The acquiring bank then sends the transaction data 126 to the appropriate card association, e.g., Visa®/MasterCard®, which routes the transaction data 126, along with an authorization request, to the correct card-issuing bank. The card-issuing bank receives the transaction data 126 and authorization request, and sends a response back to the acquiring bank with a code, indicating whether the payment is approved or declined. The acquiring bank then forwards the response code to the business-merchant 128 via the payment gateway.

Accordingly, except for those instances where a single bank is both the acquiring bank and card-issuing bank, two banks—the acquiring bank and the card-issuing bank—receive transaction data 126 related to the sale of any good and/or service. As such, banks, especially large banks having a national presence, receive transaction data 126 for a large number of transactions, and, it follows, that when administered by a large bank, the performance-measuring network 110 collects sufficient transaction data 126 to provide accurate reports regarding industry trends and the performance of specific business-merchants compared to the performance of other, competing business-merchants 128.

For illustrative purposes, the performance-measuring network 110 will be described herein as being administered by a bank-administrator 116. However, it should be appreciated that individuals, non-business entities, and business entities, other than banks, could administer the performance-measuring network 110. For example, a credit-card association or the administrator of a payment gateway could also administer the performance-measuring network 110 because these businesses and associations have access to large amounts of transaction data 126. It should also be appreciated that the performance-measuring network 110 could be administered by an individual or entity that purchases transaction data 126. This transaction data 126 could be purchased from a third-party, such as a bank or credit-card association.

Users 122 access the performance-measuring network 110 via a user terminal 124. The term “user” applies to any individual or any business or non-business entity that uses the performance-measuring network 110. For example, a user 122 could be a specific business-merchant seeking to determine how it is performing relative to competing business-merchants 128. A user 122 could also be an investor or any other individual or business or non-business entity that is interested in obtaining business performance information, e.g., a brokerage firm or a news organization.

For illustrative purposes, the performance-measuring network 110 will be described herein as being used by a “user business-merchant 122.” In the examples provided herein, the user business-merchant 122 is a specific business-merchant using the performance-measuring network 110 to measure its performance relative to other, competing business-merchants 128.

In operation, transaction data 126 is provided to the performance-measuring network 110 from business-merchants 128. For example, business-merchants 128 transmit transaction data 126 to the transaction database 132 via a business processing system 130. In an embodiment, the business processing system 130 processes credit- and debit-card transactions. For example, to execute a credit- or debit-card transaction, business-merchants 128 transmit credit- or debit-card information 126 to the business processing system 130, which, as described above, verifies the credit- or debit-card account and then processes the transaction.

In an embodiment, the business processing systems 130 include a repository of all processed credit- and debit-card transactions 126, which are made available to the performance-measuring network 110. For example, the bank-administrator 116 downloads the processed credit- and debit-card transactions 126 from the business processing systems 130 to the transaction database 132. In another embodiment, the transaction database 132 is the repository for the business processing systems 130. In this embodiment, the business processing systems 130 send transaction data 126 to the transaction database 132 upon executing a credit- or debit-card transaction. In the illustrated embodiment, an indexing tool 144 is provided for indexing the transaction database 132. This indexing makes the stored credit- and debit-card transactions 126 searchable.

The performance-measuring network 110 includes a peer-grouping tool 134 for grouping the business-merchants 128 into peer groups 136. For example, the peer-grouping tool 134 groups business-merchants 128 into peer groups 136 based on geography, size, and the type of products and services offered. An exemplary peer group 136 consists of business-merchants 128 that sell similar products and services in the same geographic region.

To provide the user business-merchant 122 with an accurate measure of its market share, the performance-measuring network 110 includes a market-share calculator 114, which compares the transaction data 126 of the user business-merchant 122 to the transaction data 126 of the other business-merchants 128 that are assigned to the same peer group(s) 136 as the user business-merchant 122. The market-share calculator 114 then generates a market-share report 118 that illustrates how the user business-merchant 122 is performing relative to other business-merchants 128 in the same peer group(s) 136. The market-share reports 118, for example, illustrate the market share of the user business-merchant 122 relative to the other business-merchants 128.

The market-share calculator 114 is configured to provide point-in-time market analysis and trend-over-time analysis. To provide point-in-time market analysis, the market-share calculator 114 accesses the transaction database 132 to obtain the latest transaction data 126. The market-share calculator 114 then compares the transaction data 126 of the specific business-merchant 128 to the transaction data 126 of the other business-merchants 128 in the same peer group 136 to provide a snapshot of specific business-merchant's 128 current market share.

To provide trend-over-time market analysis, the market-share calculator 114 obtains from the transaction database 132 historical transaction data 126, which dates back to a preselected time and is related to the business-merchants 128 of the relevant peer group(s) 136. The market-share calculator 114 then compares the historical transaction data 126 of specific business-merchant(s) 128 to the historical transaction data 126 of the rest of the business-merchants 128 in the same peer group 136. This comparison enables the market-share calculator 114 to provide a trend-over-time report of the market share of the specific business-merchant(s) 128. For example, the trend-over-time report provides data that illustrates the change in market share of the business-merchant 128 over time, and the trend-over-time report indicates whether the user business-merchant 122 is gaining or losing market share relative peer group(s) 136.

A raw data tool 140 is also provided. According to an embodiment, the raw data tool 140 provides user business-merchants 122 with direct access to the transaction data 126 stored in the transaction database 132. The raw data tool 140 includes search engines that enable user business-merchants 122 to manually search the transaction data 126, which is indexed by the indexing tool 144. For example, user business-merchants 122 can search by geographic regions, names of business-merchants 128, types of products/services, etc.

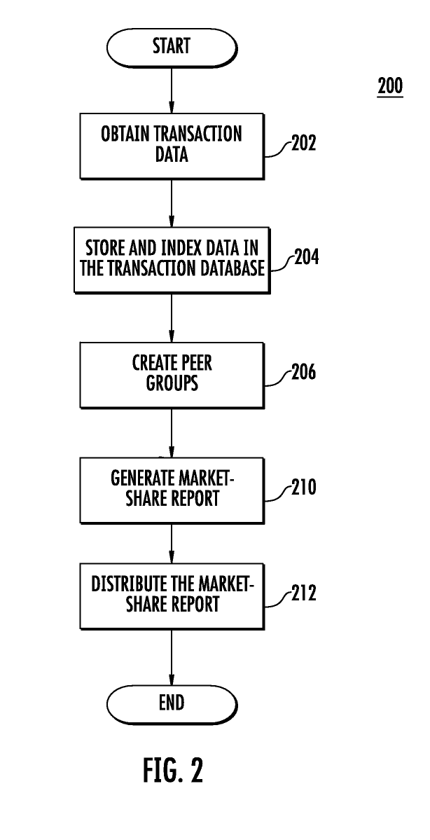

Referring now to FIG. 2, a flow chart is provided that illustrates an exemplary procedure 200 for generating market-share reports 118 by using the performance-measuring network 110 to gather transaction data 126, group business-merchants 128 into peer groups 136, and calculate the market-share held by a business-merchant 128 relative to the other business-merchants 128 in the same peer group 136. The generated market-share reports 118 can be sold or otherwise distributed. For example, the generated market-share reports 118 can be sold to and used by the business-merchants 128 and financial institutions, such as banks and corporate investors, to make management and investment decisions.

The performance-measuring network 110 generates market-share reports 118 based, in part, on transaction data 126 collected from business-merchants 128. Accordingly, in step 202, the exemplary procedure 200 generally begins with obtaining transaction data 126. In the exemplary embodiment, the transaction data 126 is credit- and debit-card transactions. These credit- and debit-card transactions are obtained by business-processing systems 130, which, in this example, are owned and managed by the bank-administrator 116. The business-processing systems 130 obtain the transaction data 126, for example, when the bank-administrator 116 is either the acquiring bank or the card-issuing bank for a credit- or debit-card transaction.

Next, in step 204, the transaction data 126 is extracted from the business-processing systems 130 and stored in the transaction database 132. Once the transaction data 126 is stored in the transaction database 132, the indexing tool 144 is used to index the transaction data 126 such that the stored transaction data 126 is searchable.

In step 206, the peer-grouping tool 134 is used to group the user business-merchants 122 into peer groups 136. The peer-grouping tool 134, according to an embodiment, is configured to automatically group user business-merchants 122 into peer groups 136. For example, the peer-grouping tool 134 groups user business-merchants 122 based on the type of products and services sold, and the geographic region(s) in which the user business-merchants 122 operate.

The peer-grouping tool 134 is also configured to enable a user business-merchant 122 to manually select business-merchants 128 for inclusion in a peer group 136. For example, as described in more detail below, the user business-merchant 122 logs into a secure website and manually assigns business-merchants 128 to peer group(s) 136.

In step 210, the market-share calculator 114 generates market-share reports 118. To do so, the market-share calculator 114 accesses the transaction database 132 and obtains transaction data 126 for each business-merchant 128 of the relevant peer groups 136. The market-share calculator 114 then compares the transaction data 126 of specific business-merchant(s) 128 to the transaction data 126 of the other business-merchants 128 in the same peer group 136. From this comparison, the market-share calculator 114 can determine the market share of the specific business-merchant(s) 128. In an embodiment, the market-share report 118 can be a trend-over-time report, which provides the change in market share over time, or a point-in-time report, which provides a snapshot of the current market share.

The market-share reports 118 are distributed in step 212. Embodiments of the present invention provide a number of ways for selling and distributing the market-share reports 118. For example, as described below, a secure website may be provided. Individuals or entities can register and pay to access the secure website to obtain market-share reports 118. Also for example, printouts and emails of the market-share reports 118 can be distributed.

Referring again to FIG. 1, a web server 150 is provided for hosting a secure website 152. User business-merchants 122 can access the secure website 152 to set up an account and avail themselves to the performance-measuring network 110. The secure website 152 of the performance-measuring network 110 can increase revenue for, and attract new customers to the bank-administrator 116 by inviting existing bank customers and non-bank customers to set up an account. For example, the bank-administrator 116 can provide a fee-based membership, which gives user business-merchants 122 access to the performance-measuring network 110. The bank-administrator 116 can, for example, target business-merchants 128 that, although may already have access to some market research, are interested in accurate market-share information about its specific market or the market generally. For example, a small business owner or even a larger retailer may already have access to some information that indicates its market position relative to its competitors, but may not have access to customizable, comprehensive, and accurate reports, such as a market-share report 118, that describes how the business is performing relative to other businesses in the same market.

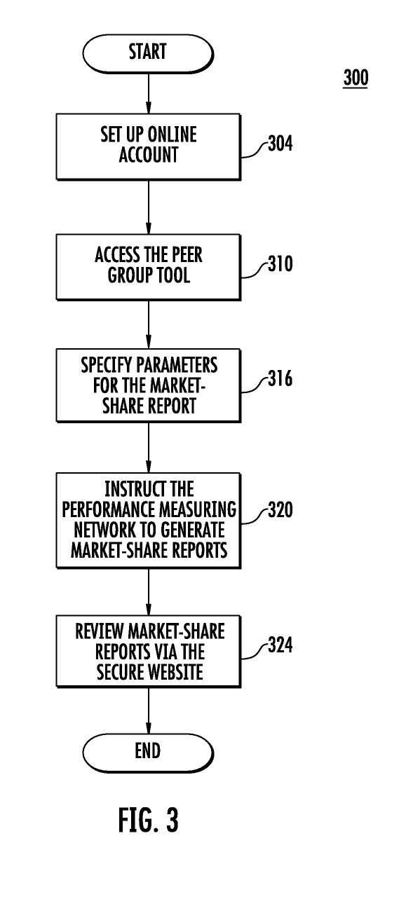

Referring now to FIG. 3, a process 300 is provided for existing bank customers and non-bank customers to access the performance-measuring network 110 via a secure website 152. In this example, existing bank customers and non-bank customers are user business-merchants 122. In step 304, the user business-merchant 122 seeking access to the performance-measuring network 110 sets up an online account. For example, the bank-administrator 116 makes available the secure website 152, which is hosted on the web server 150, to user business-merchants 122 via the user terminal 154.

User business-merchants 122 can access the secure website 152 to set up an online account. To set up online accounts, the performance-measuring network 110 obtains business and financial information from the user business-merchants 122. For example, user business-merchants 122 may provide information, such as types of products and services sold relevant geographic markets, quantities sold, and revenues. In an embodiment, this information is used by the peer-grouping tool 134 to create peer groups 136 against which the user business-merchant 128 will be compared when the market-share calculator 114 generates a market-share report 118 for the user business-merchant 122.

In an embodiment, during account set-up, the performance-measuring network 110 obtains transaction data 126 that involves the user business-merchant 122 from the transaction database 132. It should be appreciated that this transaction data 126 is updated and maintained on a regular basis. Transaction data 126 involving the user business-merchant 122 can also be obtained directly from the business processing systems 130 and/or from other institutions that maintain systems that process financial transactions such as credit- and debit-card transactions.

In step 310, the user business-merchant 122 can access the peer-grouping tool 134 via its online account to instruct the peer-grouping tool 134 to automatically create peer groups 136. To do so, for example, the peer-grouping tool 134 accesses the business and financial information provided by the user business-merchant 122 when the user business-merchant 122 sets up its online account. Also for example, the user business-merchant 122, using the peer-grouping tool 134, can manually create peer groups 136 or can specify that certain competitors be included in the automatically created peer groups 136. For example, the user business-merchant 122 can access the peer-grouping tool 134 and input other business-merchants 128, such as identified competitors, to be included in the peer group(s) 136.

The user business-merchant 122 can instruct the peer-grouping tool 134 to create a peer group consisting of all or some of the inputted competitors, or the user business-merchant 122 can instruct the peer-grouping tool 134 to create peer groups 136 comprising all or some of the inputted competitors, in addition to other merchants that were automatically identified by peer-grouping tool 134. This enables the user business-merchant 122 to obtain from the performance-measuring network 110 market-share reports 118 that include the transaction data 126 of key competitors.

The user business-merchant 122 can access the market-share calculator 114 via the secure website 152. Here, in step 316, the user business-merchant 122 can specify parameters for the market-share report 118. For example, the user business-merchant 122 can select specific peer groups 136 such that the market-share calculator 114 generates a market-share report 118 that compares the transaction volume of the user business-merchant 122 to the transaction volume of the selected peer groups 136. Such an exemplary market-share report 118 would provide the user business-merchant's 122 market share vis-à-vis each of the selected peer groups' 136 market share. The exemplary market-share report 118 could also compare the user business-merchant's 122 market share vis-à-vis the aggregate of the selected peer groups' 136 market share. User business-merchants 122, when accessing the market-share calculator 114 via the secure website 152, can also instruct the market-share calculator 114 to generate a trend-over-time market-share report 118, which includes historical data dating back to a preselected time, and/or a point-in-time market-share report 118, which provides a snapshot of the current market.

Next, in step 320, user business-merchant 122 accesses the secure website 152 to instruct the market-share calculator 114 to generate the market-share reports 118 and then, in step 324, the user business-merchant 122 views their market-share reports 118 via a display screen of the user terminal 124.

The performance-measuring network 110 is also useful for corporate investors. For example, corporate investors can set up an online account and generate market-share reports 118 for selected peer groups 136. These market-share reports 118 can be used to estimate sales volumes of specific business-merchants 128 prior to an information release.

Bank-administrators 116 can also use the performance-measuring network 110 to enhance risk management decisions. For example, bank-administrators 116 can use the performance-measuring network 110 to generate market-share reports 118 so as to identify market shifts from one type of business-merchant 128 to other types of business-merchants 128. For example, bank-administrators 116 can monitor industry trends indicating market shifts toward or away from different types of retailers, such as discount, specialty, department, etc. Bank-administrators 116 can also use these market-share reports 118 to evaluate the credit risk of merchant clients and appropriately reduce exposure to declining merchants and increase exposure to growing merchants.

Bank-administrators 116 can also use the performance-measuring network 110 to enhance affinity marketing programs. These programs typically involve co-branding credit cards. For example, bank-administrators 116 pay a designated organization, such as a university, sports team, or professional organization, a small percentage of all transactions on the credit card. To enhance affinity marketing programs, bank-administrators 116 can use the performance-measuring network 110 to create market-share reports 118 that compare specific merchants 122 to peer groups 136. Information from these market-share reports 118 can be used to convince business-merchants 128 to enter into an affinity marketing agreement with the bank-administrators 116.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for measuring the performance of a business, the method comprising:
collecting transaction data from the business and a plurality of other businesses;
grouping the business and the other businesses into a plurality of peer groups; and
generating a report that compares the transaction data of the business to the transaction data of at least one of the peer groups.

2. The method of claim 1, wherein the transaction data is a volume of transactions and the report compares the volume of transactions of the business to the volume of transactions of the peer group.

3. The method of claim 1, wherein the transaction data is revenue and the report compares the revenue of the business to the revenue of the peer group.

4. The method of claim 1, wherein the report indicates the market share that the business has relative to the peer group by comparing the volume of transactions of the business to the volume of transactions of the peer group.

5. The method of claim 1, wherein the report is a point-in-time report.

6. The method of claim 1, wherein the report is a trend-over-time report.

7. The method of claim 6, wherein the trend-over-time report indicates whether the business is gaining or losing market share relative to the peer group.

8. The method of claim 1, wherein the grouping of the business and other businesses into peer groups is based on a characteristic of the business and the other businesses.

9. The method of claim 8, wherein the characteristic is a type of product or service sold by the business and the other businesses.

10. The method of claim 8, wherein the characteristic is a geographic market.

11. The method of claim 1, wherein the transaction data includes business information, customer information, and product information.

12. The method of claim 1, wherein the data is collected from a production-processing system.

13. The method of claim 1, wherein the peer groups are automatically created by a software program.

14. The method of claim 1, wherein the peer groups are specified by the business.

15. A computer program product for measuring the performance of a business, the computer program product comprising a computer-readable medium having computer-readable program instructions stored therein, wherein said computer-readable program instructions comprise:
first instructions configured to collect transaction data from the business and a plurality of other businesses;
second instructions configured to group the business and the other businesses into a plurality of peer groups; and
third instructions configured to generate a report that compares the transaction data of the business to the transaction data of at least one of the peer groups.

16. The computer program product of claim 15, wherein the transaction data is a volume of transactions and the report compares the volume of transactions of the business to the volume of transactions of the peer group.

17. The computer program product of claim 15, wherein the transaction data is revenue and the report compares the revenue of the business to the revenue of the peer group.

18. The computer program product of claim 15, wherein the report indicates the market share that the business has relative to the peer group.

19. The computer program product of claim 15, wherein the report is a point-in-time report.

20. The computer program product of claim 15, wherein the report is a trend-over-time report.

21. The computer program product of claim 15, wherein the trend-over-time report indicates whether the business is gaining or losing market share relative to the peer group.

22. The computer program product of claim 15, wherein the grouping of the business and other businesses into peer groups is based on a characteristic of the business and the other businesses.

23. The computer program product of claim 22, wherein the characteristic is a type of product or service sold by the business and the other businesses.

24. The computer program product of claim 22, wherein the characteristic is a geographic market.

25. A system for measuring the performance of a business, the system comprising:
an input system configured to receive transaction data from the business and a plurality of other businesses; and
a processing system in communication with the input system and configured to group the business and the other businesses into a plurality of peer groups and generate a report that compares the transaction data of the business to the transaction data of at least one of the peer groups.

26. The system of claim 25, wherein the transaction data is a volume of transactions and the report compares the volume of transactions of the business to the volume of transactions of the peer group.

27. The system of claim 25, wherein the transaction data is revenue and the report compares the revenue of the business to the revenue of the peer group.

28. The system of claim 25, wherein the report indicates the market share that the business has relative to the peer group.

29. The system of claim 25, wherein the report is a point-in-time report.

30. The system of claim 25, wherein the report is a trend-over-time report.

31. The system of claim 25, wherein the trend-over-time report indicates whether the business is gaining or losing market share relative to the peer group.

32. The system of claim 25, wherein the grouping of the business and other businesses into peer groups is based on a characteristic of the business and the other businesses.

33. The system of claim 32, wherein the characteristic is a type of product or service sold by the business and the other businesses.

34. The system of claim 32, wherein the characteristic is a geographic market.
